(19) United States
(12) Patent Application Publication
(10) Pub. No.: US 2016/0006630 A1
(43) Pub. Date: Jan. 7, 2016

(54) COMPUTER SYSTEM EVALUATION METHOD, COMPUTER SYSTEM CONTROL METHOD, AND COMPUTER SYSTEM

(71) Applicant: HITACHI, LTD., Chiyoa-ku, Tokyo (JP)

(72) Inventors: Yujiro ICHIKAWA, Tokyo (JP); Yukinori SAKASHITA, Tokyo (JP); Masataka NAGURA, Tokyo (JP); Jun NAKAJIMA, Tokyo (JP)

(73) Assignee: HITACHI, LTD., Tokyo (JP)

(21) Appl. No.: 14/771,690

(22) PCT Filed: May 17, 2013
(86) PCT No.: PCT/JP2013/063764

§ 371 Date: Aug. 31, 2015

(51) Int. Cl. H04L 12/26; H04L 12/24; G06F 17/30

(52) U.S. Cl. CPC H04L 43/08; G06F 17/30876; H04L 41/24

(57) ABSTRACT

When one of nodes performs a prescribed task, a management computer: obtains a replaceable part value group containing configuration information for components of a group that includes the node, and stores the obtained replaceable part value group in history information; receives at least one node to be evaluated; obtains a replaceable part value group containing configuration information for respective components of a group that includes said node to be evaluated, and stores the obtained replaceable part value group in history comparison target information; selects a combination of the history comparison target information and the history information having matching elements; calculates an evaluation value for the selected combination of the history comparison target information and the history information; and outputs a combination of an evaluation value and a node identifier indicating the history comparison target information and the history information having the matching elements.

### BACKGROUND

The present invention relates to a technology to select and control a node such as computer or storage apparatus included in a computer system.

When a target node is to be selected from a plurality of apparatuses (nodes) having different configurations, such as when a back-up computer for an active computer is to be selected upon fail-over or a computer to install new software is to be selected, it is sometimes necessary to evaluate the degree of similarity to the past configuration information. When an apparatus needs to be replaced due to fail-over of computer (JP2011-258233 A) or volume transfer of storage, for example, the combination of apparatuses in the host computer may have changed from the combination at the time when the host computer was constructed and tested.

### SUMMARY

When the combination of apparatuses of the host computer changes, malfunction (freeze or performance degradation) possibly occurs due to the compatibility between the respective apparatuses, compatibility between an apparatus and software, or the like after the apparatus is replaced. In other words, the conventional example had a problem of not being able to determine whether or not the combination of the standby host computer can ensure stable operation.

In order to solve this problem, the present invention is aiming at making it possible to evaluate whether or not the new combination of apparatuses can ensure stable operation in advance before the change in apparatuses configuration of the host computer occurs.

The present invention includes an evaluation method of a computer system that includes a management computer having a processor and a memory and coupled with a host computer and a storage apparatus via a switch apparatus, the management computer being configured to evaluate components of nodes including the host computer and the storage apparatus, the evaluation method comprising: a first step wherein, when one of the nodes performs a prescribed task, the management computer obtains a replaceable part value group containing configuration information for components of a group that includes the node, and stores the obtained replaceable part value group in history information; a second step wherein the management computer receives at least one node to be evaluated; a third step wherein the management computer obtains a replaceable part value group containing configuration information for respective components of a group that includes said node to be evaluated, and stores the obtained replaceable part value group in history comparison target information; a fourth step wherein the management computer selects a combination of the history comparison target information and the history information having matching elements; a fifth step wherein the management computer calculates an evaluation value for the selected combination of the history comparison target information and the history information; and a sixth step wherein the management computer outputs a combination of an evaluation value and a node identifier indicating the history comparison target information and the history information having the matching elements.

According to the present invention, the management computer can store the operation history of each combination of apparatuses, and evaluate the similarity of the configuration of node to be selected to the configurations of nodes in the operation history based on the evaluation values. This allows the management computer to select a node having a configuration similar to that of an apparatus that has a proven operation history with ease, and as a result, it is possible to reduce occurrences of malfunction (such as freeze or performance degradation) after fail-over or installation of software, for example.

### BRIEF DESCRIPTIONS OF DRAWINGS

FIG. 1 is a block diagram showing a configuration of a computer system according to Embodiment 1.

FIG. 2 is a block diagram showing a configuration of the management computer according to Embodiment 1.

FIG. 3 is a block diagram showing an example configuration of the storage apparatus according to Embodiment 1.

FIG. 4 is a block diagram showing an example of the configuration of the host computer according to Embodiment 1.

FIG. 5 is a block diagram showing another example of the configuration of the host computer according to Embodiment 1.

FIG. 6 is a diagram showing an example of the trigger information for generating history information according to Embodiment 1.

FIG. 7 is a diagram showing an example of the replaceable part defined information according to Embodiment 1.

FIG. 8 is a diagram showing an example of the history information according to Embodiment 1.

FIG. 9 is a diagram showing an example of the history comparison target information according to Embodiment 1.

FIG. 10 is a diagram showing an example of the group information according to Embodiment 1.

FIG. 11 is a diagram showing an example of the configuration information according to Embodiment 1.

FIG. 12 is a diagram showing an example of the task information according to Embodiment 1.

FIG. 13 is a flowchart showing an example of processes in the history information generating process according to the Embodiment 1.

FIG. 14 is a flowchart showing an example of the replaceable part value obtaining process according to Embodiment 1.

FIG. 15A is the first half of the flowchart showing an example of the procedures of the history similarity calculating process according to Embodiment 1.

FIG. 15B is the second half of the flowchart showing an example of the procedures of the history similarity calculating process according to Embodiment 1.

FIG. 16 is an example of the replaceable part defined information according to Embodiment 2

FIG. 17A is the first half of the flowchart of the history similarity calculating process according to Embodiment 2.

FIG. 17B is the second half of the flowchart of the history similarity calculating process according to Embodiment 2.

FIG. 18 is an example of the configuration of the management computer according to Embodiment 3.

FIG. 19 is a flowchart showing an example of the process conducted by the control part according to Embodiment 3.

FIG. 20 is configuration of a computer system according to Embodiment 3.

### DETAILED DESCRIPTIONS OF EMBODIMENTS

Embodiments of the present invention will be explained with reference to the figures.

### Embodiment 1

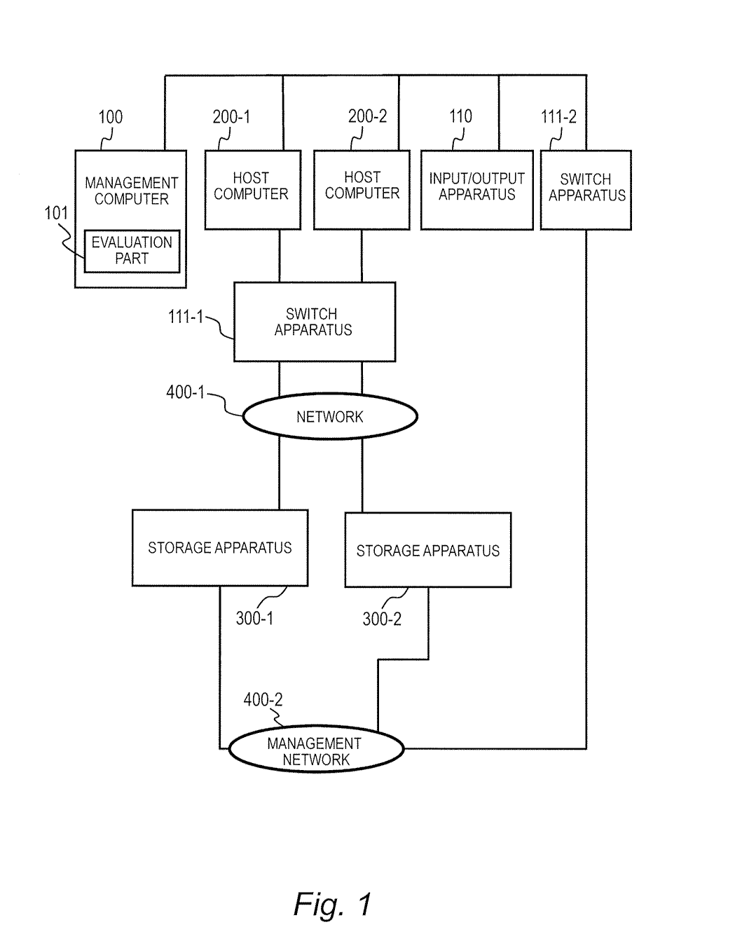

FIG. 1 is a block diagram showing a configuration of a computer system. The computer system includes: a management computer 100, one or more host computers 200-1, 200-2, one or more input/output apparatus 110, two or more switch apparatuses 111-1, 111-2, and one or more storage apparatuses 301-1, 301-2. The switch apparatus 111-1 is coupled with network 400-1. The switch apparatus 111-2 is coupled with management network 400-2. The switch apparatuses 111-1, 111-2 are collectively denoted by the reference character 111. The same applies to the host computers 200-1, 200-2, the storage apparatuses 300-1, 300-2, and the like, which are collectively denoted by the respective reference characters preceding “-.” FIG. 1 shows a configuration in which the management network 400-2 is independent of the switch apparatus 111-2, but the switch apparatus 111-2 may be included in the management network 400-2.

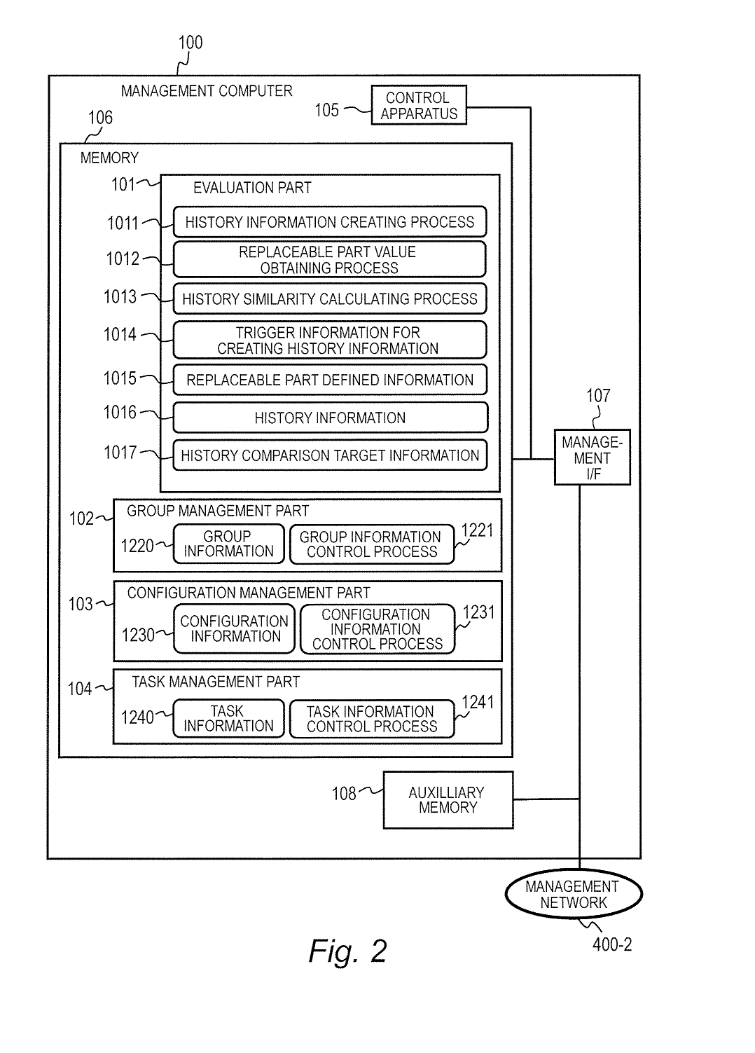

The management computer 100 is a computer that is operated by program control, and includes NIC (network interface card) coupled with the switch apparatus 111-2. This NIC is illustrated as the management interface 107 in FIG. 2 (I/F in the figure).

The management computer 100 communicates with the host computer 200, the storage apparatus 300, and the input/output apparatus 110, which are coupled with the management network 400-2, via the switch apparatus 111-2. The management computer 100 manages at least one of the host computer 200, the storage apparatus 300, and the switch apparatus 111, which are coupled with the management network 400-2, and controls those managed apparatuses and acquires information from those managed apparatuses. Below, the apparatuses that are managed by the management computer 100 will be referred to as managed nodes. The management computer 100 operates an evaluation part 101. The evaluation part 101 will be explained in detail with FIG. 2 and the subsequent drawings.

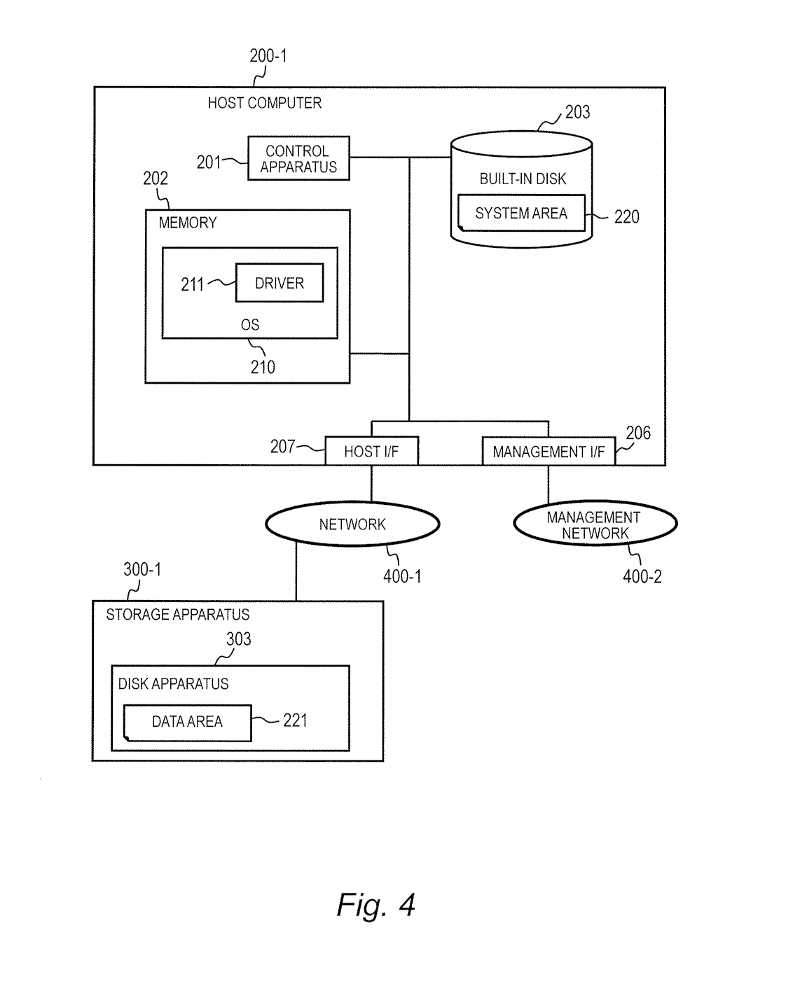

The host computer 200 is a computer that is operated by program control, and includes NIC and HBA (host bus adapter) coupled with the switch apparatus 111. This NIC is illustrated as the management interface 206 in FIG. 4 (I/F in the figure).

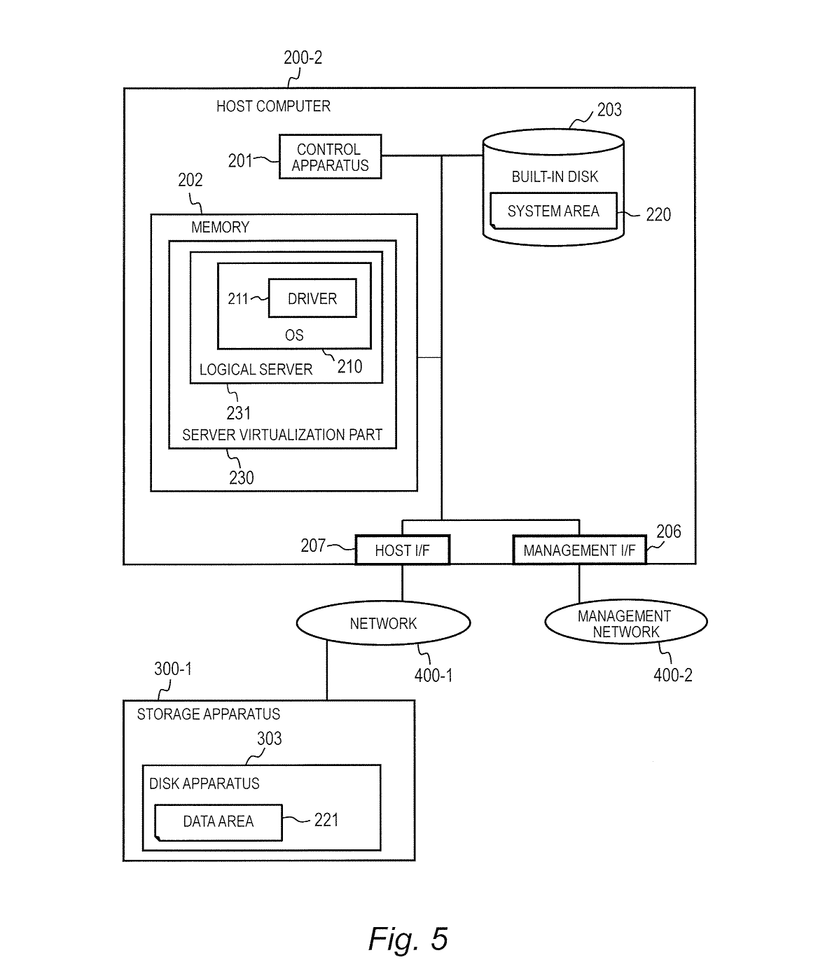

The host computer 200-1 communicates with the other host computer 200-2, the input/output apparatus 111, the storage apparatus 300 and the management computer 100, which are coupled with the management network 400-2, via the switch apparatus 111. The internal configuration of the host computer will be explained with reference to FIGS. 4 and 5.

The switch apparatus 111 contains one or more network apparatuses. Specific examples of the network apparatus include network switch, router, load balancer, firewall, and fiber channel switch.

The management network 400-2 allows for communications between the respective devices coupled with the switch apparatus 111-2 such as the management computer 100. The respective apparatuses coupled with the management network 400-2 or the network 400-1 exchange data and control information, which are processed by respective apparatuses or programs that run on the apparatuses.

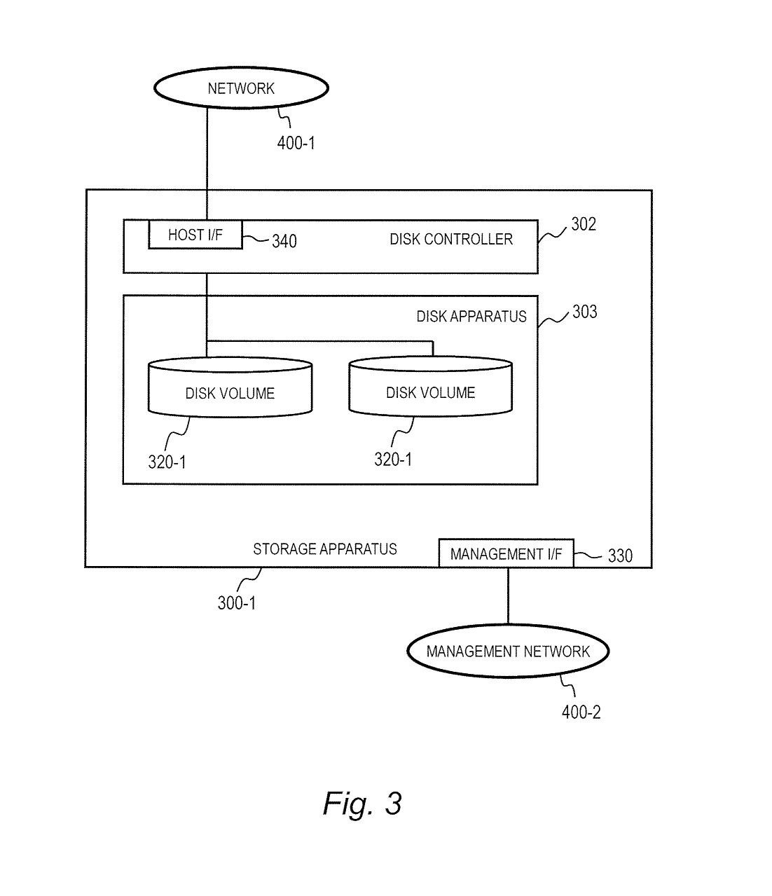

The storage apparatus 300 includes FC (fiber channel) and LAN interface, and contains at least one disk (or non-volatile memory medium) that is to be used by the management computer 100 and the host computer 200. The internal configuration of the storage apparatus 300 will be explained with reference to FIG. 3.

The input/output apparatus 110 is coupled with respective parts of the computer system such as the management computer 100 to input commands and to output responses to the commands. Specific examples of the input apparatus of the input/output apparatus 110 include a keyboard, a mouse, a touch panel, and a client computer apparatus to which those devices are connected. Specific examples of the output apparatus of the input/output apparatus 110 include a display and a client computer apparatus to which the display is connected. The input/output apparatus 110 contains NIC coupled with the switch apparatus 111-2, and through the NIC, the input/output apparatus 110 is coupled with the management computer 100 and the like, but it is also possible to couple the input/output apparatus directly with the management computer 100 and the like.

FIG. 2 is a block diagram showing a configuration of the management computer 100. The management computer 100 includes a control apparatus 105, a memory 106, and a management I/F 107. The management computer 100 is coupled with the network 400 via the management I/F 107. The memory 106 contains therein an evaluation part 101, a group management part 102, a configuration management part 103, and a task management part 104. In the present embodiment, the evaluation part 101, the group management part 102, the configuration management part 103, and the task management part 104 are programs run by a CPU (processor) in the control apparatus 105. The control apparatus 105 is an apparatus configured to control the management computer 100.

The evaluation part 101, the group management part 102, the configuration management part 103, and the task management part 104 may be implemented by hardware, firmware, or a combination thereof built in the management computer 100.

The respective programs that function as the evaluation part 101, the group management part 102, the configuration management part 103, and the task management part 104 are loaded into the memory 106, and then executed by the CPU of the control apparatus 105. The respective programs that function as the evaluation part 101, the group management part 102, the configuration management part 103, and the task management part 104 are stored in an auxiliary memory (or built-in disk) 108 in the management computer 100. Alternatively, the respective programs may be stored in the storage apparatus 300 coupled with the management computer 100 via the network 400.

The evaluation part 101 calculates evaluation values that each indicates the degree of similarity of one or more managed nodes, which are the evaluation targets, based on the operation history. The operation history is information collected from one or more managed nodes, and includes the configuration, status, and settings of the components of the nodes such as apparatuses, internal parts, and programs that run on the apparatus. In other words, the operation history is the information containing the past operation status of the components of each managed node. Below, those components will be referred to as replaceable parts. Specific examples of the apparatus information include chassis identifiers, model identifiers, product identifiers, lot numbers, serial numbers, and vendor names. Specific examples of the program information include product names, program names, build numbers, version information, revision information, and vendor names regarding software such as OS, business application, driver, and firmware. The replaceable parts are devices (such as I/O device) required to operate the OS and applications upon fail-over or take-over, for example, and if the driver used by the OS in the active system is hardware that can be used as is, such a device is a replaceable part.

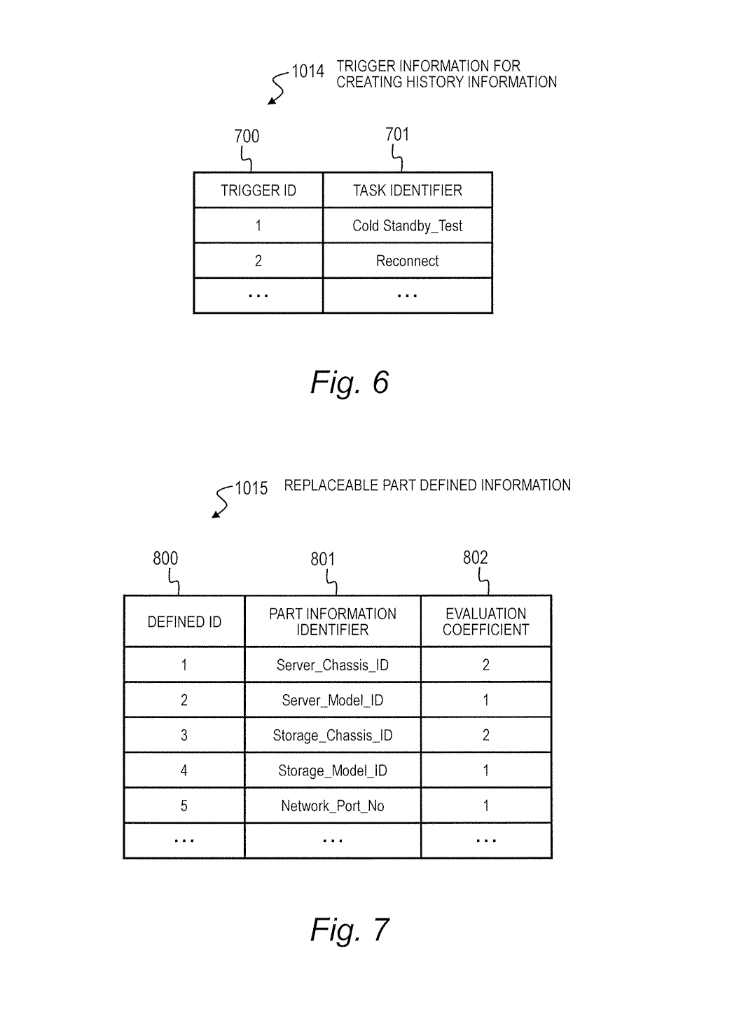

The evaluation part 101 generates the operation history before a history similarity calculating process 1013 is performed, using component information 1230 periodically collected from the managed nodes by the configuration management part 103. The history similarity calculating process 1013 is a process to calculate, as evaluation values, the degrees of similarity between the respective components by comparing the value of operation history and the value of history comparison target information 1017 collected from one or more managed nodes, i.e., the evaluation target. The history comparison target information 1017 and the calculation of evaluation values will be explained with reference to FIG. 6 and the drawings subsequent thereto. The degree of similarity indicates the degree of coincidence between the components of the managed node to be evaluated and the components of the operation history (history information 1016). When the OS is transferred to a standby computer due to fail-over or the like, for example, if the degree of similarity between the components of the active computer and the components of the standby computer is high, the OS is likely to establish stable operation in the standby computer. The degree of similarity can be used as an indicator of the likelihood of stable operation when software or hardware is transferred from one host computer 200 to another.

In order to perform the history similarity calculating process 1013, the evaluation part 101 includes a history information generating process 1011, a replaceable part value obtaining process 1012, trigger information for generating history information 1014, replaceable part defined information 1015, history information 1016, and history comparison target information 1017, each of which will be explained later with reference to FIG. 6 and the drawings subsequent thereto.

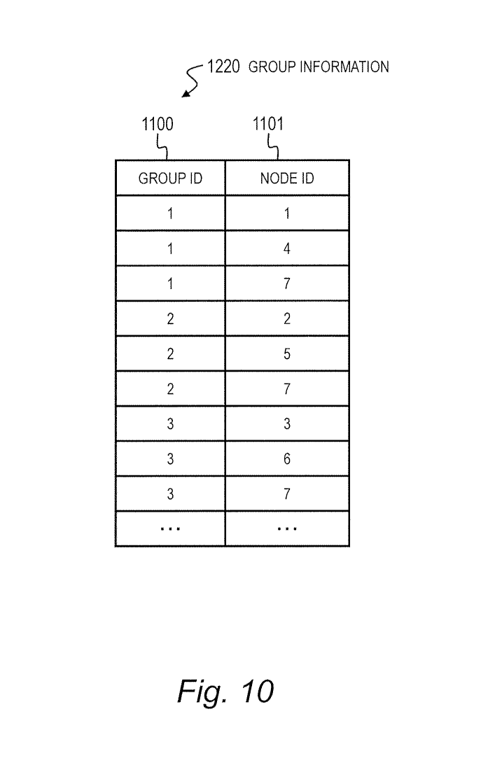

The group management part 102 manages information for coupling and usage relationships of one or more managed nodes. The group management part 102 includes group information 1220 that groups together one or more managed nodes based on the coupling and usage relationships, and a group information control process 1221 updating the group information 1220 based on the configuration information for the managed node obtained from the configuration management part 103 or a request from the user. An example of the group information will be explained with reference to FIG. 10.

The configuration management part 103 collects and stores configuration information 1230 of the host computer 200, the storage apparatus 300, and the switch apparatus 111 by conducting a configuration information control process 1231 at a prescribed interval. Examples of the configuration information 1230 include host names, IP addresses, virtual server names, logical partition configurations, volume configurations, virtual machine configurations, port numbers, and coupling and usage relationships between the storage apparatuses, the host computers and the switch apparatuses.

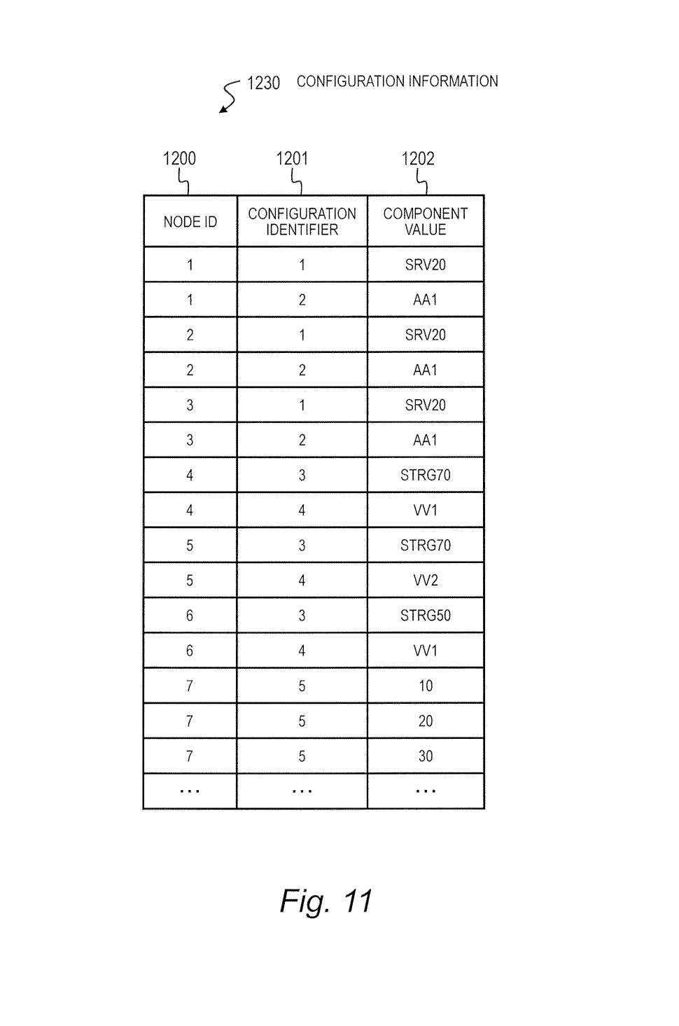

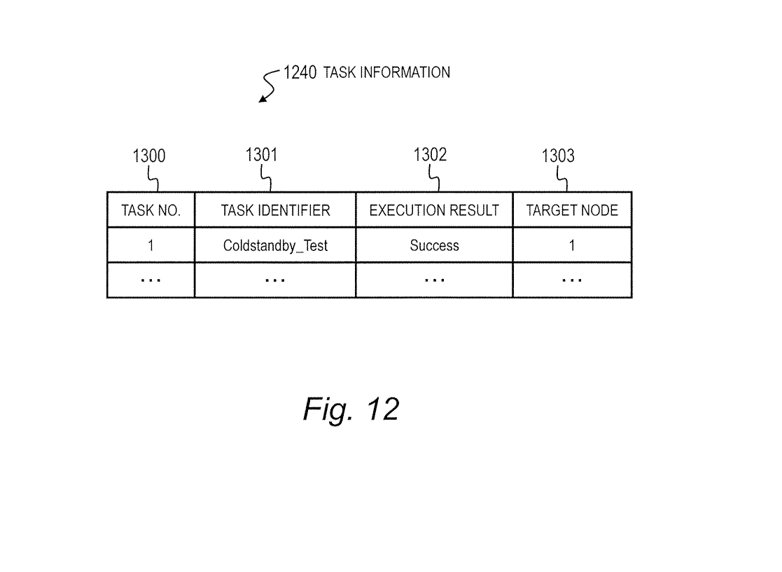

A part of the configuration information 1230 collected by the configuration management part 103 is used for the history similarity calculating process 1013 of the evaluation part 101, or the update process for the group information 1220 of the group management part 102. Below, the configuration information 1230 only contains information relating to the history similarity calculating process 1013 of the evaluation part 101. An example of the configuration information 1230 will be explained with reference to FIG. 11.

The task management part 104 holds task information 1240 collected by a task information control process 1241. The task information 1240 includes types of tasks given to the respective managed nodes and the management computer 100 such as information acquisition or control, and execution results of such tasks. An example of the task information 1240 will be explained with reference to FIG. 12.

The CPU of the control apparatus 105 achieves the functions of the above-mentioned function parts, respectively, by performing processes in accordance with the respective programs thereof. For example, the CPU of the control apparatus 105 functions as the evaluation part 101 by performing processes in accordance with the evaluation program. The same applies to other programs. The CPU of the control apparatus 105 also operates as a function part that achieves each of a plurality of processes performed in each program. The computer and computer system are a device and system that contain these function parts.

The programs for realizing the respective functions of the evaluation part 101, the group management part 102, the configuration management part 103, and the task management part 104 can be stored in a storage device such as a storage sub-system apparatus, a non-volatile semiconductor memory, hard disk drive, or SDD (solid state drive), or a computer-readable non-transitory data storage medium such as IC card, SD card, or DVD.

FIG. 3 is a block diagram showing a configuration of the storage apparatus 300. The storage apparatus 300 includes a disk controller 302, a disk apparatus 303, and a management I/F 330. The disk controller 302 is coupled with the network 400-1 via a host I/F 340. The network 400-1 is coupled with the host computer 200. The host computer 200 gains access to each storage apparatus 300 via the network 400-1. The network 400-1 is constituted of SAN (storage area network), for example.

The storage apparatus 300 is coupled with the management network 400-2 via the management I/F 330. The disk apparatus 303 includes one or more disk volumes 320-1, 320-2.

FIG. 4 is a block diagram showing an example of the configuration of the host computer 200-1. The host computer 200 includes a memory 202, a control apparatus 201, a built-in disk 203, a management I/F 206 and a host interface 207. The memory 202 stores therein software programs such as OS (operating system) 210 and drivers 211. In the present embodiment, a system area 220 of the OS 210 is held in the build-in disk 203, but it may be held in a disk apparatus 303 of the storage apparatus 300-1. The host computer 200 is coupled with the management network 400-2 and the network 400-1 via the management I/F 206 and the host I/F 207, respectively. In the present embodiment, the disk apparatus 303 of the storage apparatus 300, which is coupled with the host computer 200 via the network 400-1, holds a data area 221 used by the programs that run on the host computer 200. Alternatively, the data area 221 may be held in the built-in disk 203.

FIG. 5 is a block diagram showing another example of the configuration of the host computer 200. The host computer 200-2 of this figure differs from the host computer 200 shown in FIG. 4 in that the memory 202 further includes a server virtualization part 230 and a logical server 231. The host computer 200-2 runs programs such as OS 210 on the logical server 231. The server virtualization part 230 is a program to allocate computer resources of the host computer 200-2 to a logical partition (LPAR), and run the logical server 231 (VM: virtual machine) on this logical partition. One or more logical servers 231 operate on the server virtualization part 230. The logical server 231 operates on computer resource of the host computer 200-2 allocated by the server virtualization part 230.

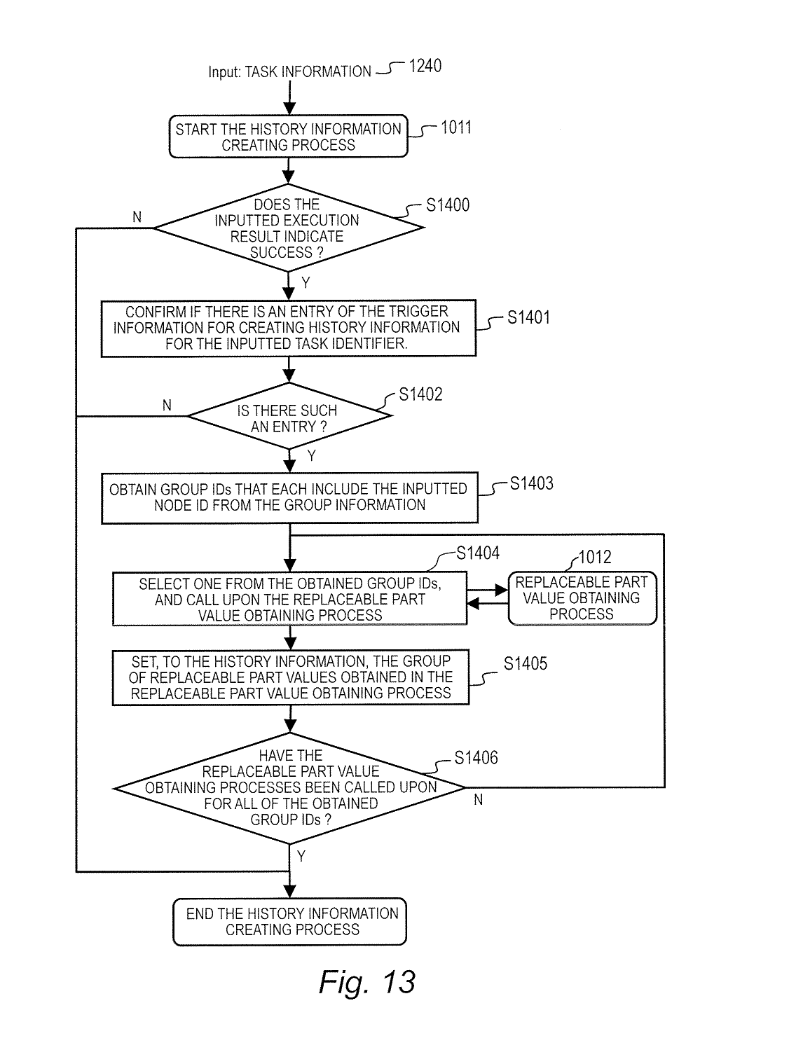

FIG. 6 is a diagram showing an example of the trigger information for generating history information 1014. The trigger information for generating history information 1014 contains information that triggers the history information generating process 1011 of the evaluation part 101. The specific manner to trigger the history information generating process 1011 will be explained with reference to FIG. 13. A trigger ID 700 is a unique ID that is given to an entry of the trigger information for generating history information 1014. A task identifier 701 is a unique identifier for the content of each task.

In the example shown in the figure, the trigger ID=2, which is for the task identifier of “reconnection,” is defined as a trigger for the history information generating process 1011. As described below, a successful execution of the task specified by the task identifier triggers the history information generating process 1011.

FIG. 7 is a diagram showing an example of the replaceable part defined information 1015. The replaceable part defined information 1015 defines a replaceable part used in the history similarity calculating process 1013 of the evaluation part 101. The replaceable part defined information 1015 defines, upon handover or the like of the computer system, replaceable parts among the components of the computer system that have been used in the past.

A defined ID 800 is a unique ID that is given to an entry of the replaceable part defined information 1015. A part information identifier 801 is a unique identifier for a replaceable part. The part information identifier 801 is generated by the evaluation part 101 based on information defined by the configuration management part 103 and the respective apparatuses of the managed nodes.

For example, when the evaluation part 101 requires a chassis name for the history similarity calculating process 1013, and when the value obtained by the evaluation part 101 from a chassis_ID acquisition I/F, which is externally published by the host computer 200, is used for a chassis name, the part information identifier 801 is named “Server_Chassis_ID” with the prefix “Server_” that denotes the host computer 200. An evaluation coefficient 802 is a weighing factor used for calculation in the history similarity calculating process 1013 by the evaluation part 101 as described below. The evaluation coefficient 802 indicates the degree of difference in environments for operating the OS 210, and the greater the evaluation coefficient 802 is, the more different the operating environment is from the initial environment in which the OS 210 was first installed.

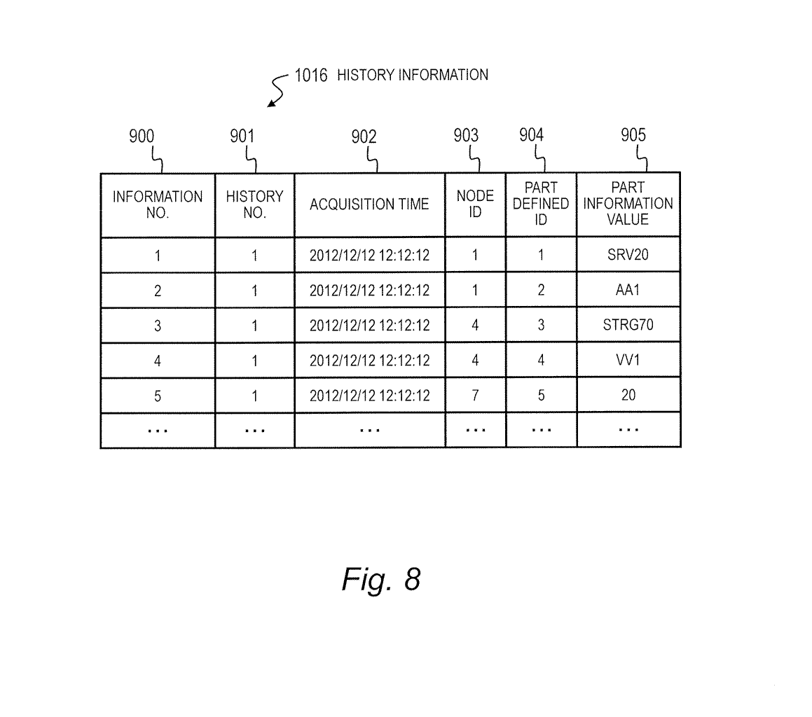

FIG. 8 is a diagram showing an example of the history information 1016. The history information 1016 contains information for the operation history of each managed node. Information No. 900 is a unique identifier that is given to an entry of the history information 1016. History No. 901 is an identifier for grouping one or more entries of the history information 1016. One or more entries of the history information 1016 are generated based on the operation history collected from one or more managed nodes every time the history information generating process 1011 is called upon. The one or more entries are given the same history No. 901. The evaluation part 101 determines the history No. 901, and examples thereof include the largest history No. 901+1, and a group ID 1100 in the group information 1220 that includes the managed node for which the history information 1016 was generated.

The entries of the history information 1016 may be updated by adding new entries constantly as in the form of a log, or overwriting the existing entries having the same history No. 901.

An acquisition time 902 is the time at which the history information 1016 was generated. A node ID 903 is an ID for a managed node specified by an entry of the history information 1016. The node ID 903 corresponds to a node ID 1200 of the configuration information 1230.

A part defined ID 904 is an identifier for the replaceable part defined information 1015 registered as the operation history. The part defined ID 904 corresponds to the defined ID 800 of the replaceable part defined information 1015. A part information value 905 is a value indicating the operation history for the part defined ID 904. The part information value 905 corresponds to a component value 1202 of the configuration information 1230.

In the example of FIG. 8, as the part information values 905 of the managed nodes, which were acquired by the management computer 100, “SRV20” indicating the chassis ID of the host computer 200-1 is stored in the information No. 1, “AA1” indicating the model of the host computer 200-1 is stored in the information No. 2, “STRG70” indicating the chassis ID of the storage apparatus 300-1 is stored in the information No. 3, “VV1” indicating the model of the storage apparatus 300-1 is stored in the information No. 4, and “20” indicating the port number of the switch apparatus 111-1 coupled with the host computer 200-1 is stored in the information No. 5.

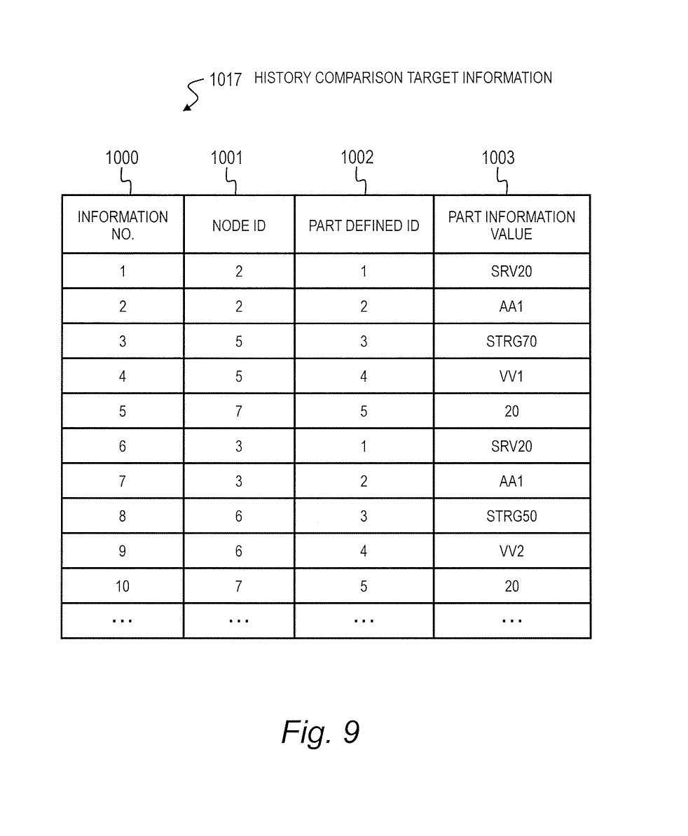

FIG. 9 is a diagram showing an example of the history comparison target information 1017. The history comparison target information 1017 is used to compare the history information 1016 with the replaceable part defined information 1015 in the history similarity calculating process 1013 of the evaluation part 101. The history comparison target information 1017 is generated by the history similarity calculating process 1013, which will be described later. Information No. 1000 is a unique identifier given to an entry of the history comparison target information 1017. A node ID 1001 is an identifier for a managed node specified by each entry of the history comparison target information 1017. The node ID 1001 corresponds to the node ID 1200 of the configuration information 1230.

A part defined ID 1002 is an identifier of the replaceable part defined information 1015 registered as the operation history. The part defined ID 1002 corresponds to the defined ID 800 of the replaceable part defining information 1015. A part information value 1003 is a value indicating the operation history for the part defined ID 904 of the history information 1016 of FIG. 8. The part information value 1003 corresponds to a component value 1202 of the configuration information 1230. This figure shows an example of generating comparison information for the nodes having IDs differing from those of the managed nodes of FIG. 8.

In the example of FIG. 9, the part information value 1003 of the information No. 1000-1 to 1000-5 are the same as those of FIG. 8, and are respectively “SRV20” indicating the chassis ID, “AA1” indicating the model, “STRG70” indicating the chassis ID of the storage apparatus 300-1, “VV1” indicating the model of the storage apparatus 300-1, and “20” indicating the port number of the switch apparatus 111-1.

FIG. 10 is a diagram showing an example of the group information 1220. A group ID 1100 is an identifier that groups together entries of the group information 1220. A node ID 1101 is an identifier for a node that belongs to each group ID 1100. The node ID 1101 corresponds to the node ID 1200 of the configuration information 1230. The value of the group ID 1100 is determined based on the coupling and usage relationship between the managed nodes. When the host computer 200 with the node ID 1101 being 1 uses the disk volume 320 of the storage apparatus 300 with the node ID being 4, for example, those apparatuses are given the same group ID. The managed nodes (node ID 1101) having the same group ID 1100 indicate the usage relationship of the computer resource that activates the host computer 200. In other words, the topology that makes up the host computer 200 can be represented by the group ID 1100 and the node ID 1101.

FIG. 11 is a diagram showing an example of the configuration information 1230. In the configuration information 1230, the component information of managed nodes obtained at a prescribed interval by the configuration information control process 1231 is saved in association with identifiers of the configuration information.

A node ID 1200 is an identifier of a managed node. A configuration identifier 1201 identifies an item of the configuration information 1230. In the present embodiment, the value of the configuration identifier 1201 corresponds to that of the defined ID 800 of the replaceable part defined information 1015, but alternatively, the configuration identifier 1201 may be determined based on the part information identifier 801 shown in FIG. 7, or may be determined based on specific names. If specific names are used, however, additional conversion information is required to indicate entries of the replaceable part defined information 1015. The component value 1202 is collected from each managed node by the evaluation part 101 for the respective configuration identifiers 1201.

In the example of FIG. 11, of the component values 1202, “SRV20” indicates the chassis ID of the host computer 200, “AA1” indicates the model of the host computer 200, “STRG70” indicates the chassis ID of the storage apparatus 300, “VV1,” “VV2” each indicate the model of the storage apparatus 300, and “10,” “20,” and “30” each indicate the port number of the switch apparatus 111.

FIG. 12 is a diagram showing an example of the task information 1240. Task No. 1300 is a unique identifier given to each entry of the task information 1240. A task identifier 1301 identifies the content of each task. An execution result 1302 stores therein the execution result of a task. In the present embodiment, the execution result of a task is indicated as Success or Failure, but values indicating True or False, numerical values of a completion code that indicates presence or absence of error, or the like may also be used. A target node 1303 is a node identifier of a managed node for which a task is executed. The target node 1303 corresponds to the node ID 1200 of the configuration information 1230.

In the example illustrated in the figure, the task specified by the task ID 1301=Coldstandby_test has been successfully executed at the target node 1303=1. Coldstandby_test is a task to conduct a process handover test from an active system to a back-up system on cold standby.

FIG. 13 is a flowchart showing an example of processes in the history information generating process 1011 of the present embodiment.

In the history information generating process 1011, when new task information 1240 is generated and inputted, the following processes are conducted to generate the history information 1016 for a group that includes the managed node for which the task is to be implemented. The task information 1240 is generated by the task management part 104. An administrator or the like gives an instruction to implement a task through the input/output apparatus 110 to the host computer 200 via the management computer 100, and the task management part 104 of the management computer 100 obtains the result of the task from the host computer 200, which is then added to the task information 1240.

The history information generating process 1011 extracts the execution result 1302 for the inputted task information 1240, and determines whether the execution result indicates success or not (Step S1400). If the execution result 1302 indicates success, the process moves to Step S1401, and if the result indicates failure, the process is ended.

The history information generating process 1011 obtains a task identifier 1301 from the inputted task information 1240, and determines whether this task identifier 1301 exists as an entry in the trigger information 700 for generating history information or not (Step S1401, S1402). If the entry of the task identifier 1301 exists in the trigger information 700 for generating history information, the process moves to Step S1403. If the entry of the task identifier 1301 does not exist in the trigger information 700 for generating history information, the process is ended (Step S1402).

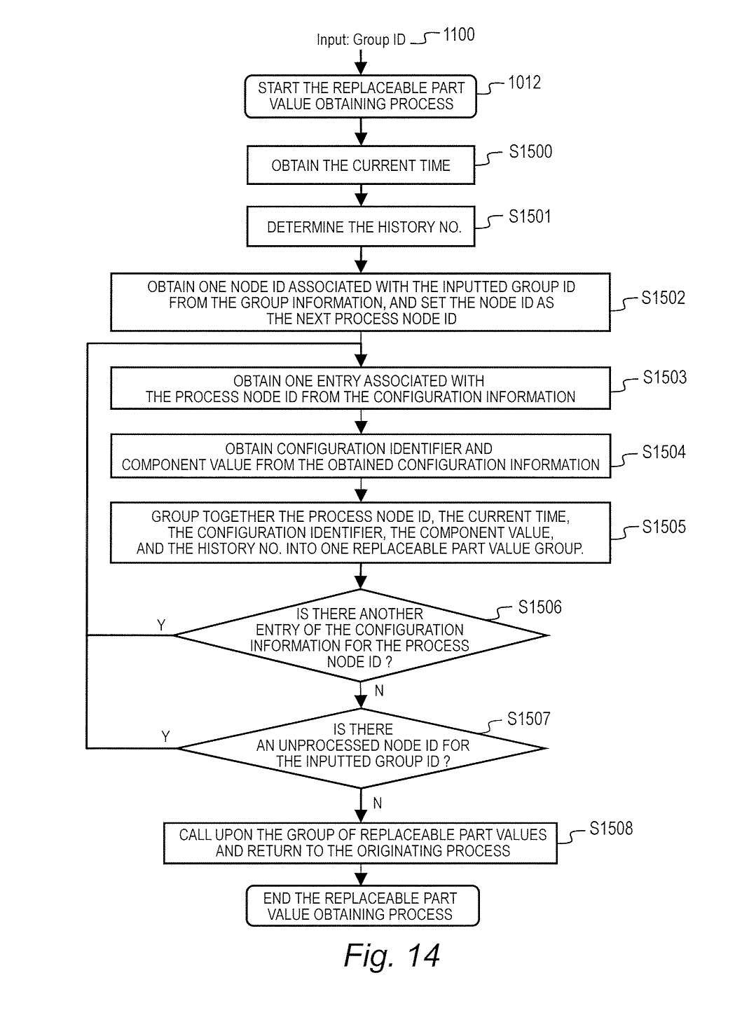

The history information generating process 1011 obtains, from the group information 1220, group IDs 1100 that include the target nodes 1303 of the inputted task information 1240 (Step S1403). The history information generating process 1011 selects one group ID from the group IDs obtained in Step S1403, and calls upon the replaceable part value obtaining process 1012, which will be described later, to receive a replaceable part value group (Step S1404). The replaceable part value group is made up of components that are selected from the configuration information 1230 and that are similar to the components of the group ID 1100 including the node to implement the task, as explained with FIG. 14 below. That is, the history information generating process 1011 obtains a replaceable part value group (replaceable part information) that represents the components in the computer system that can replace the components of the node ID for which the task is to be implemented.

The history information generating process 1011 sets, to the history information 1016 (FIG. 8), the replaceable part value group received from the replaceable part value obtaining process 1012 (S1405). The replaceable part value group is added to the history information 1016 as one record, or updates an existing record, for example.

The history information generating process 1011 determines whether the replaceable part value obtaining processes 1012 have been conducted for all of the group IDs 1100 obtained in the Step S1403 or not (S1406). If the replaceable part value obtaining processes 1012 have been conducted for all of the group IDs 1100, the process is ended, and if not, the process returns to Step S1404, and the above-mentioned steps are repeated.

Through the above-mentioned process, when the task information 1240 is generated and the execution result of the task indicated success, the replaceable part value group for each group ID 1100 that includes the managed node to implement the task is set to the history information 1016.

FIG. 14 is a flowchart showing an example of the replaceable part value obtaining process 1012 of the present embodiment. When a group ID 1100 is inputted, the replaceable part value obtaining process 1012 collects values that correspond to the replaceable part defined information 1015 for the managed node from the configuration information 1230.

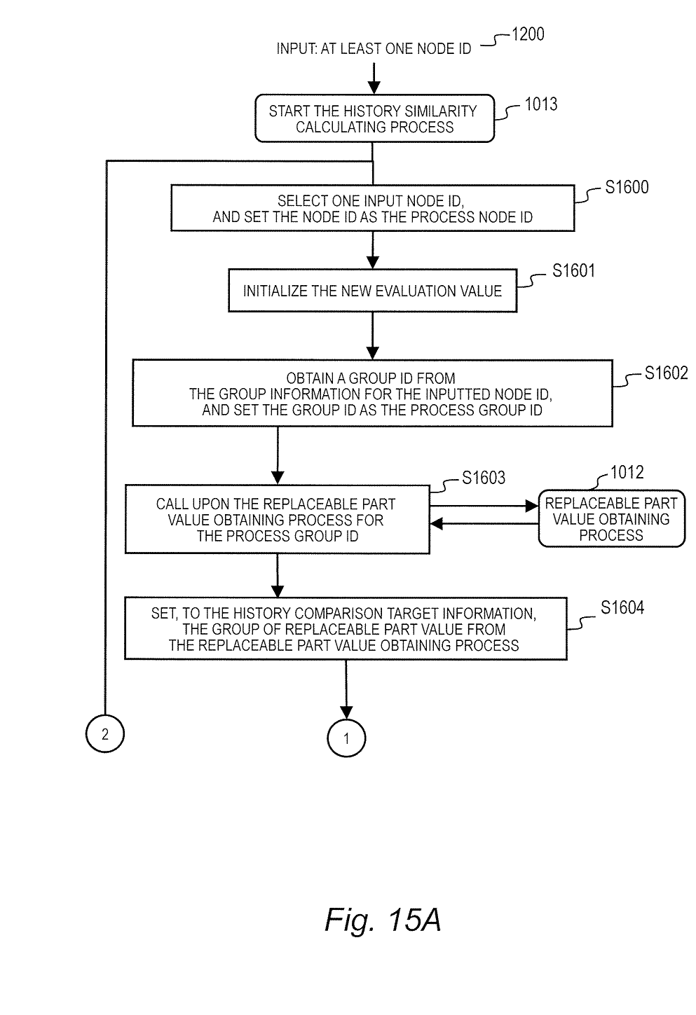

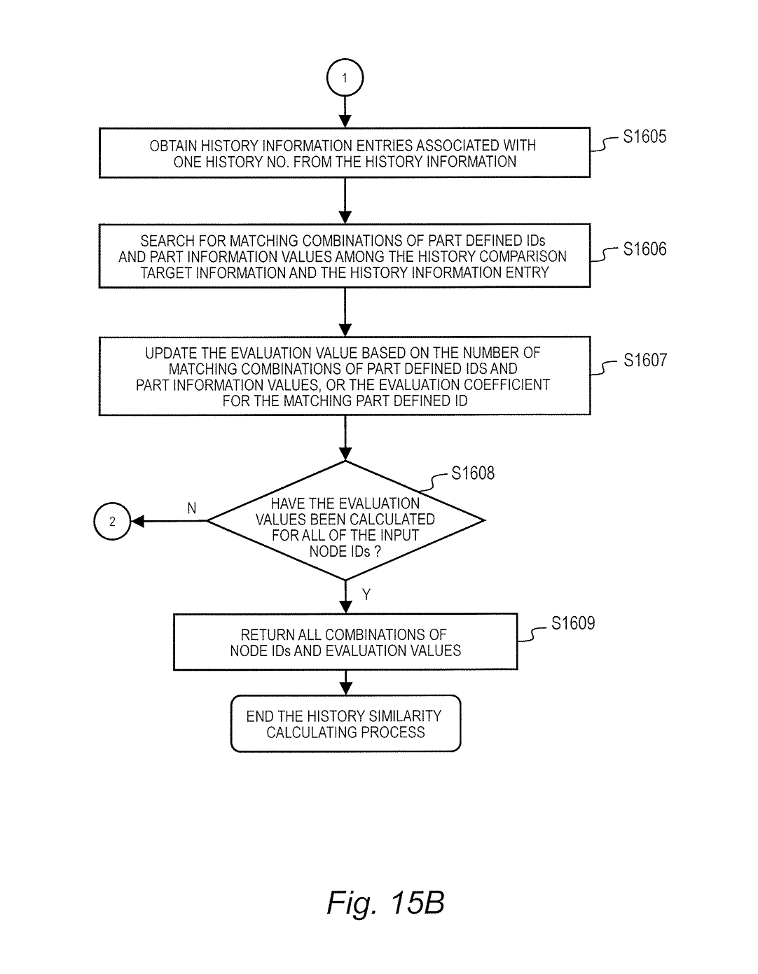

The replaceable part value obtaining process 1012 is called upon in Step S1404 of the history information generating process 1011 in order to generate the history information 1016. The replaceable part value obtaining process 1012 is also called upon in Step S1603 of the history similarity calculating process 1013 shown in FIG. 15A described later, in order to generate the history comparison target information 1017.

The replaceable part value obtaining process 1012 obtains the current time based on the OS run by the evaluation part 101, BIOS of the management computer 100, or the like. The replaceable part value obtaining process 1012 determines the history No. 901 of the history information 1016 shown in FIG. 8 (Step S1501). The value of the history No. can be a serial number or a node ID. When only the recent state of the components of the respective managed node is to be obtained, the node ID is used for the history No. 901. On the other hand, when the history of the components of the managed node is to be accumulated, a serial number is used. The administrator can choose the serial number or the node ID through the input/output apparatus 110 in advance.

The replaceable part value obtaining process 1012 obtains one node ID 1101 associated with the inputted group ID 1100 with reference to the group information 1220, and sets this node ID 1101 for the next process node ID (Step S1502).

The replaceable part value obtaining process 1012 then obtains one entry associated with the process node ID with reference to the configuration information 1230 (Step S1503). The replaceable part value obtaining process 1012 obtains the configuration identifier 1201 and the component value 1202 from the entry of the configuration information 1230 obtained in the previous step (Step S1504).

The replaceable part value obtaining process 1012 groups together the process node ID, the current time obtained in Step S1500, the history No. determined in Step S1501, and the configuration identifier 1201 and the component value 1202 obtained in Step S1504 into one replaceable part value group (Step S1505). This replaceable part value group is the information that is set as an entry of the history information 1016 and the history comparison subject information 1017.

The replaceable part value obtaining process 1012 determines whether another entry associated with the process node ID exists or not with reference to the configuration information 1230 (Step S1506). If another entry exists, the process goes back to Step S1503, and the above-mentioned steps are repeated. On the other hand, if no entry that corresponds to the process node ID exists, the process moves to Step S1507.

The replaceable part value obtaining process 1012 determines whether the replaceable part value group has been acquired for all node IDs for the input group ID or not (or in other words, whether there is an unprocessed node ID or not) with reference to the group information 1220 (Step S1507). If an unprocessed node ID still exists, the process goes back to Step S1503, and the above-mentioned steps are repeated. On the other hand, if the replaceable part value group has been acquired for all of the node IDs corresponding to the input group ID, the process moves to Step S1508. Then, the replaceable part value obtaining process 1012 calls upon and returns the replaceable part value groups to the original process (Step S1508), and the process is ended.

Through the process described above, the node IDs 1101 that correspond to the input group ID are obtained from the group information 1220, and a configuration identifier 1201 and a component value 1202 are obtained for each of the node IDs 1101, which are then grouped into a replaceable part value group. Thereafter, the obtained replaceable part value groups are sent to the original process that called upon the replaceable part value obtaining process 1012.

FIGS. 15A and 15B are flowcharts showing an example of procedures of the history similarity calculating process 1013 of the present embodiment. FIG. 15A shows the first half of the flowchart showing an example of the procedures of the history similarity calculating process 1013, and FIG. 15B shows the second half of the flowchart showing an example of the procedures of the history similarity calculating process 1013.

The history similarity calculating process 1013 receives an input of at least one node ID, which is the comparison target for the operation history, and by generating the history comparison target information 1017 and comparing the generated history comparison target information 1017 with the history information 1016, outputs the evaluation value.

The history similarity calculating process 1013 is called upon through the evaluation part 101 when the management computer 100 or the administrator who operates the management computer 100 through the input/output apparatus 110 conducts the history similarity calculating process 1013 for two or more managed nodes based on the operation history.

The history similarity calculating process 1013 is conducted when selecting a destination node to transfer the current active node from two or more standby nodes, and when selecting a host computer for installing a software program of OS or the server virtualization part from two or more new host computers 200, for example.

The history similarity calculating process 1013 is started when one or more node IDs are received. The history similarity calculating process 1013 selects one node ID from the received node IDs, and sets the node ID as the process node ID (Step S1600).

The history similarity calculating process 1013 initializes a prescribed variable that holds a new evaluation value (Step S1601). In the present invention, the new evaluation value is initialized to 1. The history similarity calculating process 1013 obtains a group ID 1100 that corresponds to the process node ID from the group information 1220, and sets the obtained value as the process group ID (Step S1602).

The history similarity calculating process 1013 calls upon the replaceable part value obtaining process 1012 shown in FIG. 14, and obtains a replaceable part value group corresponding to the process group ID (Step 1603). The history similarity calculating process 1013 sets the replaceable part value group obtained in Step S1603 to the history comparison target information 1017 for temporary storage (S1604). In the present embodiment, the replaceable part value group was set to the history similarity target information 1017 for temporary storage, but it is also possible to use a variable that corresponds to the content of the history similarity target information 1017.

The history similarity calculating process 1013 obtains an entry of the history information 1016 associated with one history No. 901 (Step S1605).

The history similarity calculating process 1013 searches for matching combinations of the part defined IDs (904, 1002) and the part information values (905, 1003) among the history comparison target information 1017 set in Step S1604 and the entry of the history information 1016 obtained in Step S1605, by comparing respective values (Step S1606).

The history similarity calculating process 1013 calculates and updates a new evaluation value using the number of matching combinations of the part defined IDs (904, 1002) and part information values (905, 1003) obtained in Step S1606, or evaluation coefficients 802 for the matching part defined IDs (904, 1002). The evaluation coefficients 802 are associated with the defined IDs 800 that correspond to the part defined IDs 904, and are obtained from the replaceable part defined information 1015 by the history similarity calculating process 1013.

The history similarity calculating process 1013 calculates a new evaluation value by adding four (quantity of items) to the evaluation value when there are four matching items, for example, or multiplying the evaluation value by two (evaluation coefficient 802 of Server_Chassis_ID) when Server_Chassis_ID of FIG. 7 is deemed to match, for example.

The history similarity calculating process 1013 determines whether the evaluation values have been calculated for all of the input node IDs or not (Step S1608). If the evaluation values have been calculated for all of the input node IDs, the process moves to Step S1609, and after outputting the combinations of the node IDs and evaluation values, the process is ended.

Through the above-described process, with respect to the input of the node IDs to be evaluated, replaceable part value groups for the components of the group IDs that include the input node IDs are obtained and stored in the history comparison target information 1017. The history similarity calculating process 1013 of the evaluation part 101 then selects combinations of the history comparison target information 1017 and the history information 1016 with matching elements (part defined IDs, part information values), and calculates evaluation values for those combinations of the history comparison target information 1017 and the history information 1016 with matching elements. Thereafter, the history similarity calculating process 1013 of the evaluation part 101 outputs the respective combinations of the node IDs and evaluation values for the history comparison target information 1017 and the history information 1016 with matching elements.

Through this process, evaluation values are calculated based on the history comparison target information 1017 and the history information 1016 having matching combinations of the part defined IDs 1002 and the part information values 1003, and it is possible to evaluate the degree of similarity of the operation history of respective combinations of apparatuses and the operation history of the configurations of the available nodes. This allows the management computer 100 to select a node that has a configuration similar to the apparatus with proven operation history with ease, and the occurrence of problems (freeze or performance degradation) after fail-over or installation of software can be suppressed.

### Embodiment 2

In Embodiment 1 above, the process to evaluate the degree of similarity of replaceable part defined information 1015 to the operation history was described. In Embodiment 2, the replaceable part defined information 1015 has a priority level.

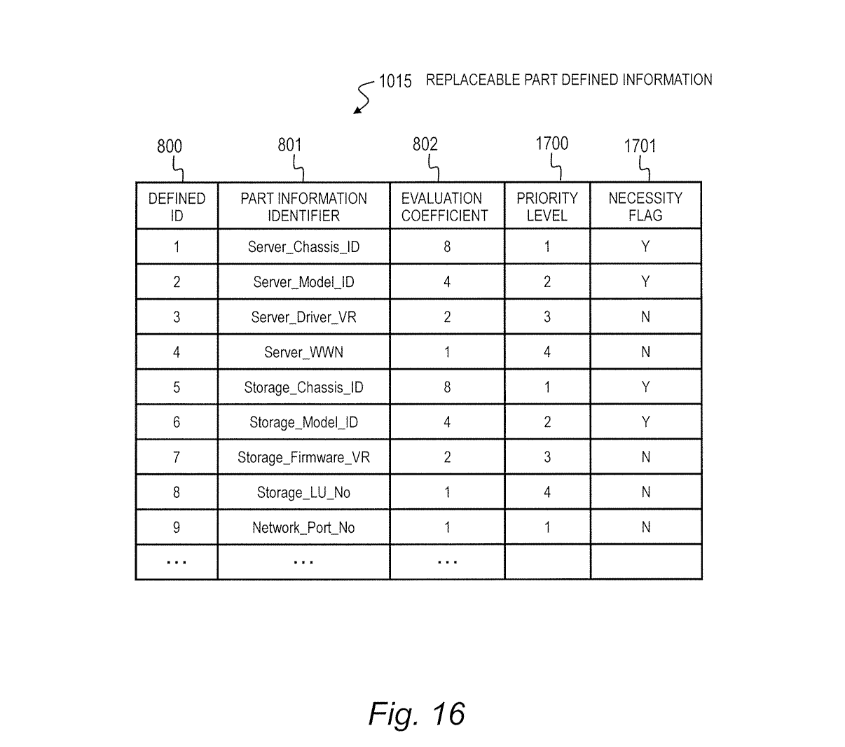

FIG. 16 shows an example of the replaceable part defined information 1015 of Embodiment 2. In this embodiment, a priority level 1700 and a necessity flag 1701 are newly added. Other configurations are the same as those of Embodiment 1.

The priority level 1700 is set based on the granularity of part information identifier 801, or in other words, based on the size of the effect of a change in replaceable part defined information on a host system. For example, Server_Chassis_ID, which is the chassis information of the host computer 200, has a larger granularity than that for Server_Driver_VR, which is the driver version information, i.e., one component of the host computer 200 (or in other words, a change in chassis information causes a change on the chassis level), and therefore, the priority level of Server_Chassis_ID is higher. The priority level 1700 is related to the order to calculate evaluation values in the history similarity calculating process 1013. In the example of the figure, the smaller the value under the priority level 1700 is, the higher the priority is.

The necessity flag 1701 indicates whether comparison values for the part information identifiers 801 need to match or not in the history similarity calculating process 1013. In the present embodiment, Y (true) indicates that it is necessary, and N (false) indicates that it is not necessary, but true/false values or values that correspond to true/false values may alternatively be used. In the history similarity calculating process 1013, if the values for the part information identifiers with the necessity flag 1701 indicating True do not match, the evaluation value is invalid (0 or negative value, for example).

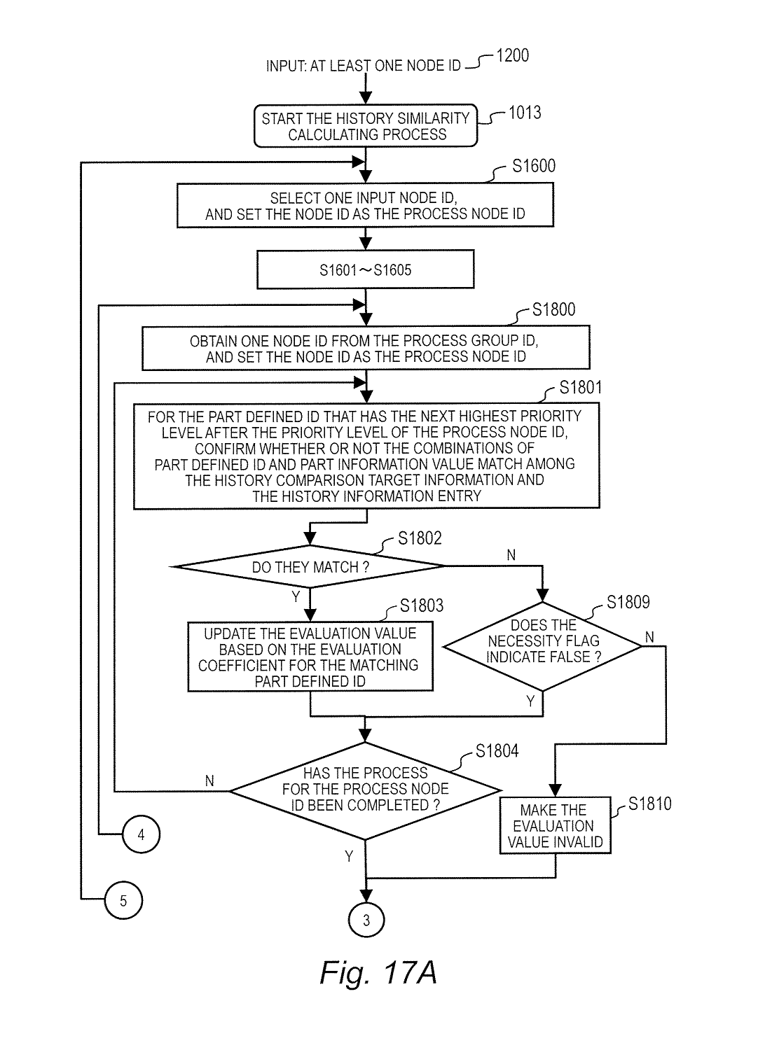

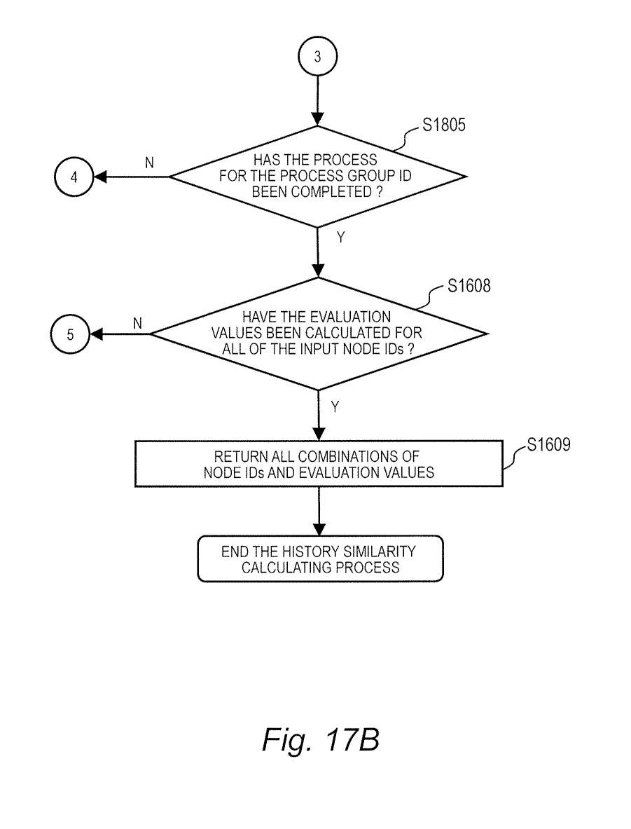

FIGS. 17A and 17B are flowcharts showing an example of the history similarity calculating process of Embodiment 2. FIG. 17A shows the first half of the flowchart of the history similarity calculating process, and FIG. 17B shows the second half of the flowchart of the history similarity calculating process.

The history similarity calculating process 1013 of FIGS. 17A and 17B differs from the history similarity calculating process 1013 of FIGS. 15A and 15B of Embodiment 1 above in the calculation method for the evaluation values. The history similarity calculating process 1013 of FIGS. 15A and 15B calculates the evaluation value based on the number of matching combinations in the replaceable part defined information 1015. On the other hand, in the history similarity calculating process 1013 of FIGS. 17A and 17B, the value comparison is conducted first for the replaceable part defined information 1015 having a higher priority level 1700 (or greater granularity). If the values are deemed unmatched, the comparison process for the rest of the replaceable part defined information 1015 will be skipped. This is because a change in replaceable part defined information 1015 having greater granularity largely reduces the possibility that the rest of the replaceable part defined information is found similar to the operation history. For example, even when the driver version of a node matches that of the operation history, if the chassis type does not match, an unknown chassis is used for the node.

For this reason, FIGS. 17A and 17B differ from FIGS. 15A and 15B of Embodiment 1 above in that Step S1606 and Step S1607 are omitted, and Step S1800 to Step S1805 are newly added.

The history similarity calculating process 1013 obtains, in Step S1800, one node ID that corresponds to the process group ID, and sets the obtained value for the process node ID (Step S1800).

The history similarity calculating process 1013 obtains the part defined ID 904 that corresponds to the process node ID with reference to the history information 1016. The history similarity calculating process 1013 then obtains the priority level 1700 of the defined ID 800 that corresponds to the part defined ID 904 with reference to the replaceable part defined information 1015.

The history similarity calculating process 1013 obtains a defined ID 800 that has the next highest priority level 1700 to the obtained priority level 1700, and determines whether combinations of part defined IDs and part information values match each other among the history comparison target information 1017 and the entry of the history information 1016 (Step S1801). If the combinations match, the process moves to Step S1803, and if not, the process moves to S1809 (Step S1802).

The history similarity calculating process 1013 obtains an evaluation coefficient 802 associated with the matching part defined ID (904, 1002, 800), and updates the evaluation value by calculating a new evaluation value using the evaluation coefficient 802 (Step S1803).

The history similarity calculating process 1013 then determines whether the process from Step S1801 to Step S1803 has been completed for the process node ID (Step S1804). If the process for the process node ID has been completed, the history similarity calculating process 1013 moves to Step S1805, and if not, returns to Step S1801 and repeats the steps described above.

The history similarity calculating process 1013 determines whether the process from Step S1800 to Step S1804 has been completed for the process group ID (Step S1805). If the process from Step S1800 to Step S1804 for the process ID has been completed, the history similarity calculating process 1800 moves to Step S1608, and if not, returns to Step S1800 and repeats the steps described above.

In Step S1802, if the history comparison target information 1017 and the history information 1016 are deemed not matching, the history similarity calculating process 1013 determines whether the necessity flag 1701 for the part defined ID (904, 1002) and the defined ID (800) indicates False or not (Step S1809). If False, the process moves to Step S1804, and conducts the above-mentioned process. If the necessity flag 1701 indicates True, the process moves to Step S1810. The history similarity calculating process 1013 makes the current evaluation value invalid (0 or negative value, for example) because the necessity flag indicates True (Step S1810).

As described above, with Embodiment 2 of the present invention, in the case where the replaceable part defined information 1015 has the priority level, the similarity of the specific components of the managed nodes to the operation history can be calculated as evaluation values, and based on the evaluation values, the similarity can be evaluated.

### Embodiment 3

Embodiment 2 described the process to calculate the similarity of the specific components of the managed nodes to the operation history as evaluation values when the replaceable part defined information 1015 has a priority level. Embodiment 3 describes a process to control the managed nodes based on the evaluation values calculated in Embodiment 1 or Embodiment 2 above (fail-over, for example).

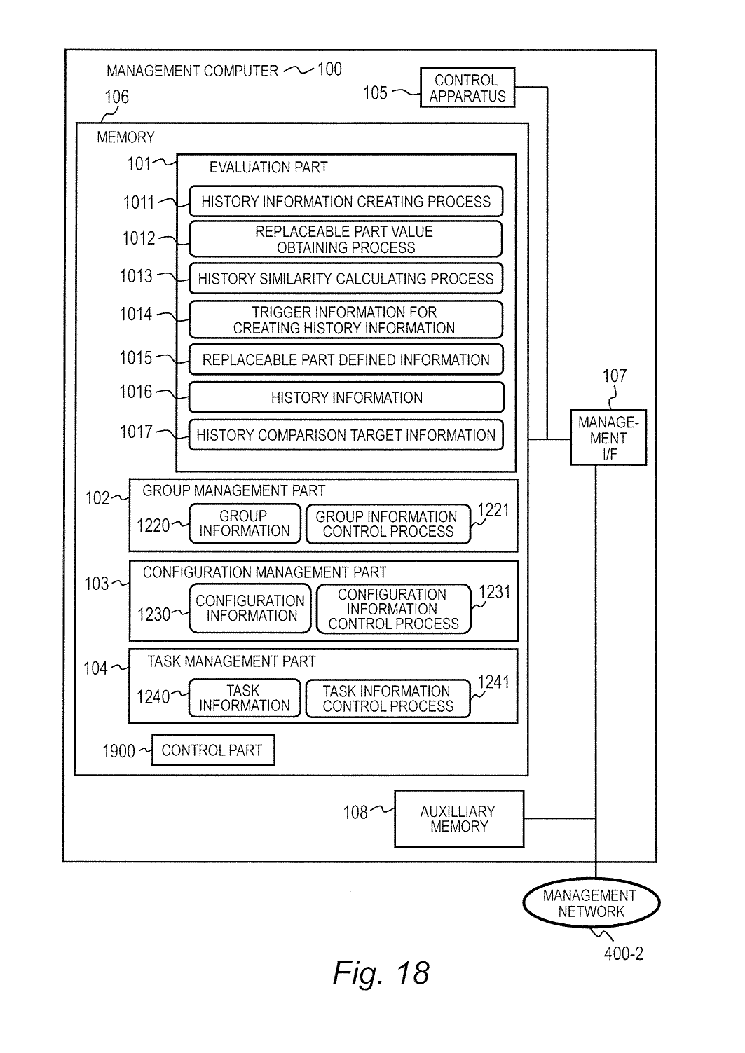

FIG. 18 shows an example of the configuration of the management computer 100 of the present embodiment. As shown in FIG. 18, a control part 1900 is added to the management computer 100. Other configurations are similar to those of Embodiments 1 and 2 described above.

The control part 1900 changes the configuration or status of the managed nodes in accordance with a request from the management computer 100 or an administrator operating the management computer 100. Examples of the request include fail-over of a host computer 200, or installation of software such as OS or server virtualization part in a new host computer 200. In the present embodiment, the control scope of the control part 1900 is separated from the control scopes of the group information control process 1221, the configuration information control process 1231, and the task information control process 1241, but these control scopes may be consolidated into the control part 1900.

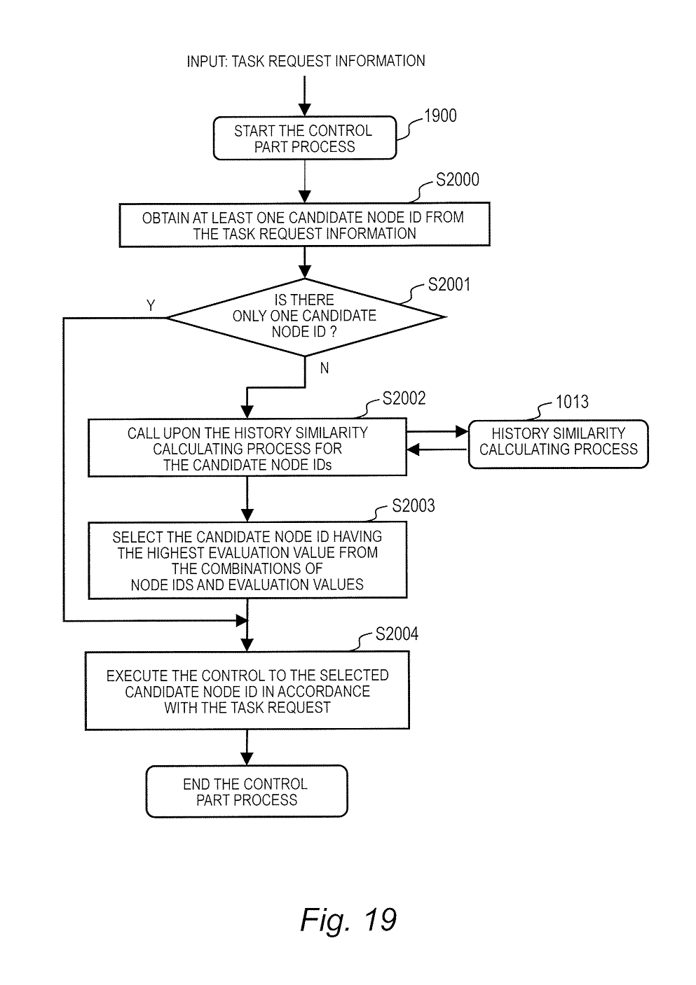

FIG. 19 is a flowchart showing an example of the process conducted by the control part 1900. The control part 1900 selects a managed node to be controlled based on an input of task request information, and implements the control process. The task request information includes the content of the task and one or more candidate node IDs that are to be controlled. Examples of the content of the task include fail-over and installation of software as described above. The control part 1900 obtains one or more candidate node IDs from the task request information (Step S2000).

The control part 1900 determines whether or not there is only one candidate node ID (Step S2001). If there is only one candidate node ID, the process moves to Step S2004 where the control is implemented. If there are more than one node IDs, the process moves to Step S2002 to select a candidate node ID having the greatest evaluation value.

The control part 1900 calls upon the history similarity calculating process 1013 for the candidate node IDs (Step S2002). The control part 1900 obtains combinations of the candidate node IDs and evaluation values from the history similarity calculating process 1013, and then selects, as the candidate node ID, a node ID having the greatest evaluation value from the combinations of node IDs and evaluation values (Step S2003). The control part 1900 implements the control in accordance with the task request information on the candidate node ID selected above (Step S2004).

With the present embodiment, the evaluation part 101 can control the managed node based on the calculated evaluation values (fail-over, for example). In the example of the fail-over, selecting a node with a greater evaluation value makes it possible to select a destination node having a higher degree of similarity to the components of the originating node. This reduces a change in components of the node that runs OS or applications after transfer, and stable operation of the OS and applications in a new node is ensured. In other words, by reducing a change in components of the destination node, a change in running environment of software can be suppressed, which prevents occurrence of freeze or degradation of process capability.

### Modification Example

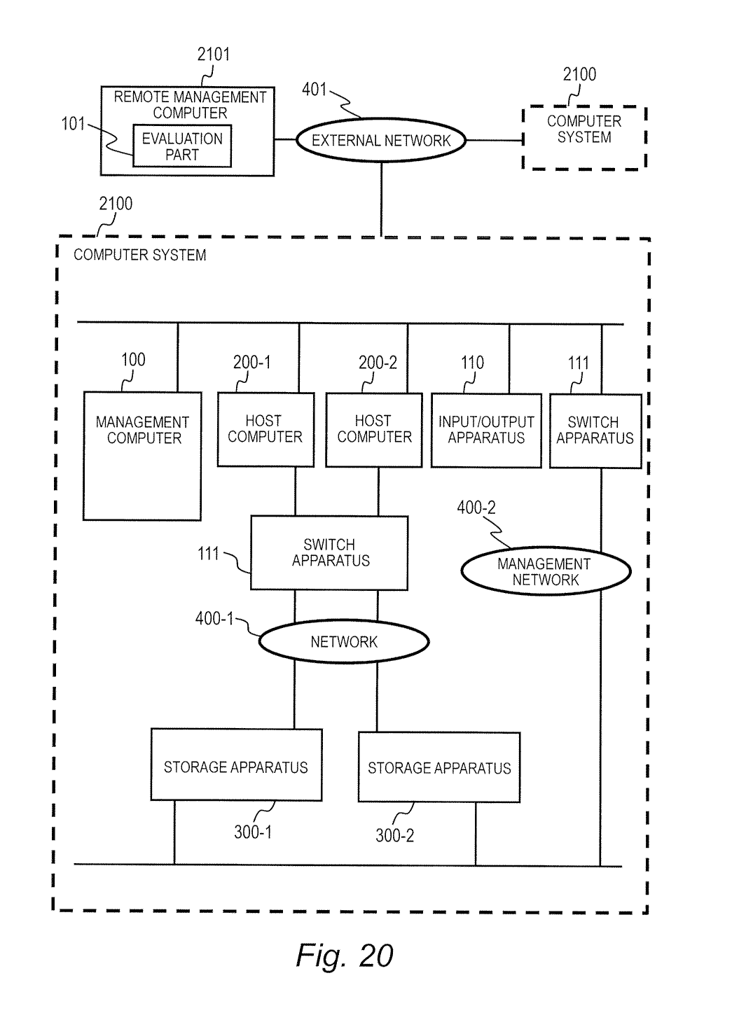

FIG. 20 shows another configuration of a computer system. In FIG. 20, a computer system 2100, which is the computer system shown in FIG. 1, is coupled with a remote management computer 2101 via an external network 401. One or more computer systems 2100 are coupled with the external network 401. Instead of the management computer 100 of Embodiment 1 above, the remote management computer 2101 operates the evaluation part 101.

The external network 401 is the Internet with the encrypted communication capability, or wide area network connected via special lines. The remote management computer 2101 communicates with the management computer 100 in the computer system 2100 via the external network 401, thereby operating the evaluation part 101.

Any one of the evaluation parts 101 of Embodiment 1 to Embodiment 3 may be used. In this case, in a manner similar to Embodiment 1 to Embodiment 3 above, combinations of node IDs and evaluation values in each computer system 2100 can be calculated.

The above-described configurations, functions, and processors, for all or a part of them, may be implemented by dedicated hardware.

The above-described software may be stored in an electric, electromagnetic, or optical storage device or the like, and may be downloaded to a computer via a network such as internet.

This invention is not limited to the above-described embodiments but includes various modifications. The above-described embodiments are explained in details for better understanding of this invention and are not limited to those including all the configurations described above.

1. An evaluation method of a computer system that includes a management computer having a processor and a memory and coupled with a host computer and a storage apparatus via a switch apparatus, the management computer being configured to evaluate components of nodes including the host computer and the storage apparatus, the evaluation method comprising:
a first step wherein, when one of the nodes performs a prescribed task, the management computer obtains a replaceable part value group containing configuration information for components of a group that includes the node, and stores the obtained replaceable part value group in history information;
a second step wherein the management computer receives at least one node to be evaluated;
a third step wherein the management computer obtains a replaceable part value group containing configuration information for respective components of a group that includes said node to be evaluated, and stores the obtained replaceable part value group in history comparison target information;
a fourth step wherein the management computer selects a combination of the history comparison target information and the history information having matching elements;
a fifth step wherein the management computer calculates an evaluation value for the selected combination of the history comparison target information and the history information; and
a sixth step wherein the management computer outputs a combination of an evaluation value and a node identifier indicating the history comparison target information and the history information having the matching elements.

2. The evaluation method of a computer system according to claim 1,
wherein the replaceable part value includes an identifier that defines a component of the node and a part information identifier,
wherein the history information includes an identifier for the node, a part defined identifier, and a part information value,
wherein the history comparison target information includes an identifier of the node, a part defined identifier, and a part information value, and
wherein, in the fourth step, the management computer selects a combination of the history comparison target information and the history information having the part defined identifier and the part information value matching each other.

3. The evaluation method of a computer system according to claim 1,
wherein the management computer has replaceable part defined information that includes an evaluation coefficient and a priority level for the configuration information,
wherein, in the fourth step, the management computer compares the elements of the history comparison target information and the history information based on the priority level, and
wherein, in the fifth step, the management computer obtains, from the replaceable part defined information, an evaluation coefficient that corresponds to the configuration information represented by the selected combination of the history comparison target information and the history information, and calculates the evaluation value based on said evaluation coefficient.

4. The evaluation method of a computer system according to claim 3,
wherein the replaceable part defined information further includes a necessity flag that determines validity or invalidity of the calculated evaluation value, and
wherein, in the fifth step, if the necessity flag indicates invalid, the management computer makes the evaluation value invalid.

5. The evaluation method of a computer system according to claim 3,
wherein the replaceable part defined information includes, as the configuration information, at least one of chassis information, model information, driver information, firmware information, and software configuration information for each of the host computer, the storage apparatus, and the switch apparatus.

6. An control method of a computer system that includes a management computer having a processor and a memory and coupled with a host computer and a storage apparatus via a switch apparatus, the management computer being configured to control components of nodes including the host computer and the storage apparatus, the control method comprising:
a first step wherein, when one of the nodes performs a prescribed task, the management computer obtains a replaceable part value group containing configuration information for components of a group that includes the node, and stores the obtained replaceable part value group in history information;
a second step wherein the management computer receives at least one node to be controlled and content of the control for said node;
a third step wherein the management computer obtains a replaceable part value group containing configuration information for each component of a group that includes said node to be controlled, and stores the obtained replaceable part value group in history comparison target information;
a fourth step wherein the management computer selects a combination of the history comparison target information and the history information having matching elements;
a fifth step wherein the management computer calculates an evaluation value for the selected combination of the history comparison target information and the history information;
a sixth step wherein the management computer selects, as a node to be controlled, a combination of an evaluation value and a node identifier for the history comparison target information and the history information having the matching elements; and
a seventh step wherein the management computer conducts the control on said node selected as a node to be controlled.

7. The control method of a computer system according to claim 6,
wherein the replaceable part value includes an identifier that defines a component of the node and a part information identifier,
wherein the history information includes an identifier of the node, a part defined identifier, and a part information value,
wherein the history comparison target information includes an identifier of the node, a part defined identifier, and a part information value, and
wherein, in the fourth step, the management computer selects a combination of the history comparison target information and the history information with the part defined identifiers and the part information values matching each other.

8. The control method of a computer system according to claim 6,
wherein the management computer has replaceable part defined information that includes an evaluation coefficient and a priority level for the configuration information,
wherein, in the fourth step, the management computer compares the elements of the history comparison target information and the history based on the priority level, and
wherein, in the fifth step, the management computer obtains, from the replaceable part defined information, an evaluation coefficient that corresponds to the configuration information represented by the selected combination of the history comparison target information and the history information, and calculates the evaluation value based on said evaluation coefficient.

9. The control method of a computer system according to claim 8,
wherein the replaceable part defined information further includes a necessity flag that determines validity or invalidity of the calculated evaluation value, and
wherein, in the fifth step, if the necessity flag indicates invalid, the management computer makes the evaluation value invalid.

10. The control method of a computer system according to claim 8,
wherein the replaceable part defined information includes, as the configuration information, at least one of chassis information, model information, driver information, firmware information, and software configuration information for each of the host computer, the storage apparatus, and the switch apparatus.

11. A computer system, comprising:
a management computer having a processor and a memory;
a host computer; and
a storage apparatus,
wherein the management computer is coupled with the host computer and the storage apparatus via a switch apparatus,
wherein the management computer is configured to evaluate components of nodes including the host computer and the storage apparatus, and
wherein the management computer includes:
a replaceable part value obtaining part that receives a group including said node and that obtains a replaceable part value group including configuration information for components of the group;
a history information generating part that obtains, when one of the nodes conducts a prescribed task, a replaceable part value group for components of the group including said node from the replaceable part value obtaining part, and the history information generating part storing the obtained replaceable part value group in history information; and
a history similarity calculating part that receives at least one node to be evaluated, obtains a replaceable part value group including configuration information for respective components of a group including said node to be evaluated from the replaceable part value obtaining part, stores the obtained replaceable part value group in history comparison target information, selects a combination of the history comparison target information and the history information having matching elements, calculates an evaluation value for the selected combination of the history comparison target information and the history information, and outputs a combination of an evaluation value and a node identifier of the history comparison target information and the history information having matching elements.

12. The computer system according to claim 11,
wherein the replaceable part value includes an identifier that defines a component of the node and a part information identifier,
wherein the history information includes an identifier of the node, a part defined identifier, and a part information value,
wherein the history comparison target information includes an identifier of the node, a part defined identifier, and a part information value, and
wherein the history similarity calculating part selects a combination of the history comparison target information and the history information with the part defined identifiers and the part information values matching each other.

13. The computer system according to claim 11,
wherein the management computer has replaceable part defined information that includes an evaluation coefficient for the configuration information and a priority level, and
wherein the history similarity calculating part compares elements of the history comparison target information and the history information based on the priority level, obtains, from the replaceable part defined information, an evaluation coefficient that corresponds to the configuration information represented by the selected combination of the history comparison target information and the history information, and calculates the evaluation value based on said evaluation coefficient.

14. The computer system according to claim 13,
wherein the replaceable part defined information includes a necessity flag that determines validity or invalidity of the calculated evaluation value, and
wherein, in the fifth step, if the necessity flag indicates invalid, the evaluation value is made invalid.

15. The computer system according to claim 13,
wherein the replaceable part defined information includes, as the configuration information, at least one of chassis information, model information, driver information, firmware information, and software configuration information for each of the host computer, the storage apparatus, and the switch apparatus.
